(19) United States
(12) Patent Application Publication
(10) Pub. No.: US 2023/0386733 A1
(43) Pub. Date: Nov. 30, 2023

(54) ELECTRONIC COMPONENT AND METHOD FOR MANUFACTURING ELECTRONIC COMPONENT

(71) Applicant: Murata Manufacturing Co., Ltd., Kyoto-fu (JP)

(72) Inventors: Hiromitsu ITO, Nagaokakyo-shi (JP); Yuichi IIDA, Nagaokakyo-shi (JP)

(73) Assignee: Murata Manufacturing Co., Ltd., Kyoto-fu (JP)

(21) Appl. No.: 18/322,284

(22) Filed: May 23, 2023

(30) Foreign Application Priority Data
May 24, 2022 (JP) 2022-084784

(51) Int. Cl. H01F 27/29; H01F 41/04; C03C 15/00; H01F 17/00; C03C 19/00

(52) U.S. Cl. CPC H01F 27/292; H01F 41/041; C03C 15/00; H01F 17/0006; C03C 19/00; H01F 2017/0073; C03C 2204/08

(57) ABSTRACT

An electronic component includes a glass substrate, an outer surface conductor that is in contact with an outer surface of the glass substrate, and a protective film that covers the outer surface of the glass substrate and the outer surface conductor and is in contact with the outer surface of the glass substrate and the outer surface conductor. When the glass substrate has first surface roughness Ra1 at an interface between the glass substrate and the outer surface conductor, the glass substrate has second surface roughness Ra2 at an interface between the glass substrate and the protective film, and the outer surface conductor has third surface roughness Ra3 at an interface between the outer surface conductor and the protective film, Ra1<Ra3<Ra2 is satisfied.

### CROSS-REFERENCE TO RELATED APPLICATION

This application claims benefit of priority to Japanese Patent Application No. 2022-084784, filed May 24, 2022, the entire content of which is incorporated herein by reference.

### BACKGROUND

### Technical Field

The present disclosure relates to an electronic component and a method for manufacturing the electronic component.

### Background Art

Conventionally, as an electronic component, there has been the electronic component described in Japanese Unexamined Patent Application Publication No. 2020-174169. The electronic component includes a glass substrate, an outer surface conductor that is in contact with an outer surface of the glass substrate, and a protective film that is in contact with the outer surface of the glass substrate and the outer surface conductor so as to cover the outer surface conductor.

### SUMMARY

When the conventional electronic component is actually manufactured and used, there is a problem in which the protective film peels off of the glass substrate. This is caused by weak adhesion between the protective film and the glass substrate due to the smooth outer surface of the glass substrate. Therefore, making the outer surface of the glass substrate rough can be considered, but the problem is that the surface of the outer surface conductor in contact with the outer surface of the glass substrate becomes rough, and when a high frequency signal passes through the outer surface conductor, a current concentrates on the rough surface portion of the outer surface conductor, thereby causing a problem of an increase in the loss of the high frequency signal.

Therefore, the present disclosure provides an electronic component capable of reducing loss of a high frequency signal and reducing peeling of a protective film and a method for manufacturing the electronic component.

An electronic component as an aspect of the present disclosure includes a glass substrate, an outer surface conductor that is in contact with an outer surface of the glass substrate, and a protective film that covers the outer surface of the glass substrate and the outer surface conductor and is in contact with the outer surface of the glass substrate and the outer surface conductor. When the glass substrate has first surface roughness Ra1 at an interface between the glass substrate and the outer surface conductor, the glass substrate has second surface roughness Ra2 at an interface between the glass substrate and the protective film, and the outer surface conductor has third surface roughness Ra3 at an interface between the outer surface conductor and the protective film, Ra1<Ra3<Ra2 is satisfied.

In the specification, the first surface roughness Ra1 of the glass substrate is the average value of the surface roughness in the entire region of the interface between the glass substrate and the outer surface conductor. The second surface roughness Ra2 of the glass substrate is the average value of the surface roughness in the entire region of the interface between the glass substrate and the protective film. The third surface roughness Ra3 of the outer surface conductor is the average value of the surface roughness in the entire region of the interface between the outer surface conductor and the protective film.

According to the aspect, since Ra1<Ra3<Ra2 is satisfied, the loss of a high frequency signal can be reduced, and the peeling of the protective film can be reduced.

Preferably, in an embodiment of the electronic component, (Ra3−Ra1)<(Ra2−Ra3) is satisfied.

According to the embodiment, since the third surface roughness Ra3 is closer to the first surface roughness Ra1 than the second surface roughness Ra2, the surface roughness of the surface, of the outer surface conductor, in contact with the protective film becomes small. Therefore, when a high frequency signal passes through a surface of the outer surface conductor, the concentration of a current on the surface of the outer surface conductor can be reduced, and the loss of the high frequency signal can be further reduced.

Preferably, in an embodiment of the electronic component, a first through conductor and a second through conductor that penetrate the glass substrate are further included. Also, the outer surface includes a bottom surface, which is one main surface of the glass substrate, and a top surface located on a back side of the bottom surface. The outer surface conductor includes a bottom surface conductor that is in contact with the bottom surface and a top surface conductor that is in contact with the top surface, and the bottom surface conductor, the first through conductor, the top surface conductor, and the second through conductor are connected in order and configure a part of a spiral coil.

According to the embodiment, the configuration can be applied to an inductor component.

Preferably, in an embodiment of the electronic component, the protective film includes a first protective layer that covers the outer surface conductor and a second protective layer that covers the first protective layer and the outer surface of the glass substrate.

According to the embodiment, the third surface roughness Ra3 of the outer surface conductor at the interface between the outer surface conductor and the protective film (first protective layer) can be made small, and the surface roughness of the surface of the outer surface conductor in contact with the protective film can be made small. Therefore, when a high frequency signal passes through a surface of the outer surface conductor, the concentration of a current on the surface of the outer surface conductor can be reduced, and the loss of the high frequency signal can be further reduced.

Moreover, even when the third surface roughness Ra3 of the outer surface conductor is made small, as fourth surface roughness of the first protective layer at an interface between the first protective layer and the second protective layer is made large, the adhesion between the first protective layer and the second protective layer can be improved, and the peeling of the second protective layer can be reduced.

Preferably, in an embodiment of the electronic component, when the first protective layer has fourth surface roughness Ra4 at an interface between the first protective layer and the second protective layer, Ra1<Ra4 is satisfied.

According to the embodiment, since the fourth surface roughness Ra4 is larger than the first surface roughness Ra1, the adhesion between the first protective layer and the second protective layer can be improved, and the peeling of the second protective layer can be reduced.

Preferably, a method for manufacturing an electronic component according to an embodiment includes providing an outer surface conductor that is in contact with an outer surface of a glass substrate, performing a surface treatment on the outer surface of the glass substrate, and providing a protective film that covers the outer surface of the glass substrate and the outer surface conductor and is in contact with the outer surface of the glass substrate and the outer surface conductor. When the glass substrate has first surface roughness Ra1 at an interface between the glass substrate and the outer surface conductor, the glass substrate has second surface roughness Ra2 at an interface between the glass substrate and the protective film, and the outer surface conductor has third surface roughness Ra3 at an interface between the outer surface conductor and the protective film, Ra1<Ra3<Ra2 is satisfied.

According to the embodiment, since Ra1<Ra3<Ra2 is satisfied, the loss of a high frequency signal can be reduced, and the peeling of the protective film can be reduced.

Preferably, in an embodiment of the method for manufacturing an electronic component, the performing a surface treatment on the outer surface conductor includes performing a surface treatment on the outer surface of the glass substrate after providing a mask in at least a part of the outer surface conductor. Also, the providing a protective film includes providing the protective film that covers the outer surface of the glass substrate and the outer surface conductor after removing the mask from the outer surface conductor.

According to the embodiment, since the surface treatment is performed on the outer surface of the glass substrate after proving a mask on the outer surface conductor, the surface treatment can be selectively performed not on a surface of the outer surface conductor, but on the outer surface of the glass substrate.

Preferably, a method for manufacturing an electronic component according to an embodiment includes providing an outer surface conductor that is in contact with an outer surface of a glass substrate, providing a first protective layer of a protective film that covers the outer surface conductor and is in contact with the outer surface conductor, performing a surface treatment on the outer surface of the glass substrate and the first protective layer, and providing a second protective layer of the protective film that covers the outer surface of the glass substrate and the first protective layer and is in contact with the outer surface of the glass substrate and the first protective layer. When the glass substrate has first surface roughness Ra1 at an interface between the glass substrate and the outer surface conductor, the glass substrate has second surface roughness Ra2 at an interface between the glass substrate and the second protective layer, and the outer surface conductor has third surface roughness Ra3 at an interface between the outer surface conductor and the first protective layer, Ra1<Ra3<Ra2 is satisfied.

According to the embodiment, since Ra1<Ra3<Ra2 is satisfied, the loss of a high frequency signal can be reduced, and the peeling of the protective film can be reduced.

According to the electronic component as an aspect of the present disclosure and the method for manufacturing the electronic component, loss of a high frequency signal can be reduced, and peeling of a protective film can be reduced.

### BRIEF DESCRIPTION OF THE DRAWINGS

FIG. 1 is an exploded perspective view illustrating a first embodiment of an inductor component as an electronic component;

FIG. 2 is a sectional view of the inductor component;

FIG. 3A is a top view of a coil of the inductor component when viewed from the top surface side;

FIG. 3B is a bottom view of the coil of the inductor component when viewed from the bottom surface side;

FIG. 4 is an enlarged sectional view of the inductor component;

FIG. 5A is a sectional view for explaining a method for manufacturing the inductor component;

FIG. 5B is a sectional view for explaining the method for manufacturing the inductor component;

FIG. 5C is a sectional view for explaining the method for manufacturing the inductor component;

FIG. 5D is a sectional view for explaining the method for manufacturing the inductor component;

FIG. 6 is an enlarged sectional view illustrating a second embodiment of an inductor component as an electronic component;

FIG. 7A is a sectional view for explaining a method for manufacturing the inductor component;

FIG. 7B is a sectional view for explaining the method for manufacturing the inductor component;

FIG. 7C is a sectional view for explaining the method for manufacturing the inductor component;

FIG. 7D is a sectional view for explaining the method for manufacturing the inductor component;

FIG. 8 is an enlarged sectional view illustrating a third embodiment of an inductor component as an electronic component;

FIG. 9A is a sectional view for explaining a method for manufacturing the inductor component;

FIG. 9B is a sectional view for explaining the method for manufacturing the inductor component;

FIG. 9C is a sectional view for explaining the method for manufacturing the inductor component;

FIG. 9D is a sectional view for explaining the method for manufacturing the inductor component; and

FIG. 10 is a sectional view illustrating a fourth embodiment of a capacitor component as an electronic component.

### DETAILED DESCRIPTION

An electronic component as an aspect of the present disclosure and a method for manufacturing the electronic component will be described in detail with illustrated embodiments below. It is noted that some of the drawings are schematic and the drawings do not reflect actual dimensions and ratios in some cases.

### First Embodiment

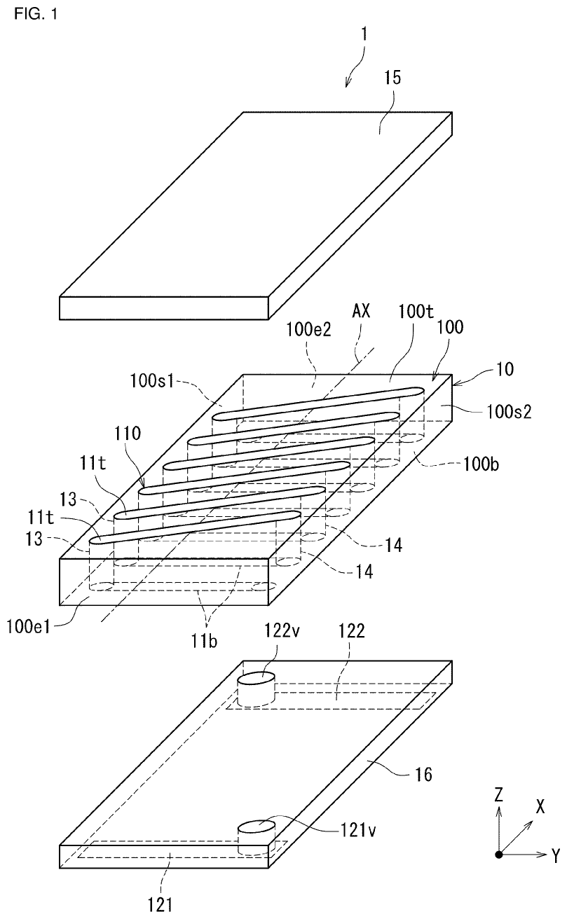

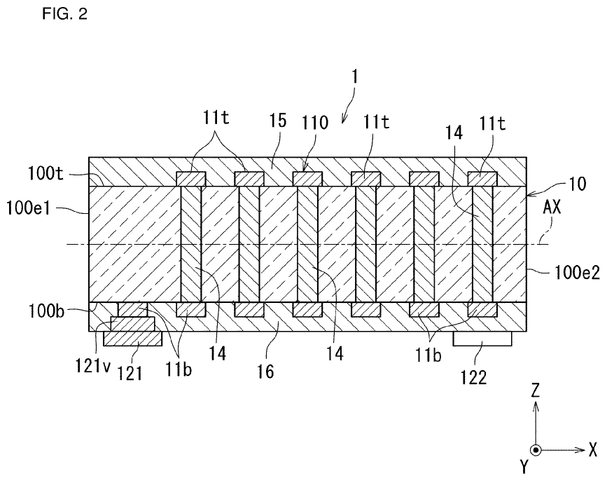

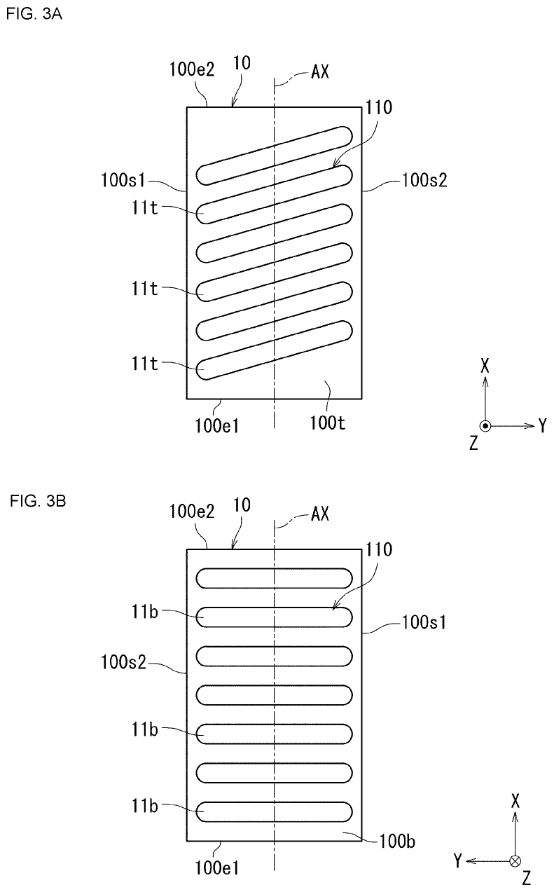

In a first embodiment, an inductor component will be described as an example of an electronic component according to the present disclosure. FIG. 1 is an exploded perspective view of the inductor component when viewed from a top surface side. FIG. 2 is a sectional view of the inductor component. FIG. 3A is a top view of a coil of the inductor component when viewed from the top surface side, and FIG. 3B is a bottom view of the coil of the inductor component when viewed from the bottom surface side.

An inductor component 1 is, for example, a surface mounting inductor component used for a high frequency signal transmission circuit. As illustrated in FIGS. 1, 2, 3A, and 3B, the inductor component 1 includes a glass substrate 10, a coil 110 provided in the glass substrate 10, a first protective film 15 and a second protective film 16 provided on the glass substrate 10 and covering a part of the coil 110, and a first terminal electrode 121 and a second terminal electrode 122 provided on the second protective film 16 and electrically connected to the coil 110.

Glass Substrate 10

The glass substrate 10 has a rectangular parallelopiped shape having a length, a width, and a height. The glass substrate 10 has a first end surface 100e1 and a second end surface 100e2 on respective end sides in a length direction, a first side surface 100s1 and a second side surface 100s2 on respective end sides in a width direction, and a bottom surface 100b and a top surface 100t on respective end sides in a height direction. That is, an outer surface 100 of the glass substrate 10 includes the first end surface 100e1 and the second end surface 100e2, the first side surface 100s1 and the second side surface 100s2, and the bottom surface 100b and the top surface 100t. The bottom surface 100b is one of the main surfaces of the glass substrate 10, and the top surface 100t is located on a back side of the bottom surface 100b.

Note that as illustrated in the drawings, hereinafter, for the convenience of explanation, a direction that is the length direction (longitudinal direction) of the glass substrate 10 and the direction extending from the first end surface 100e1 to the second end surface 100e2 is referred to as an X direction. In addition, a direction that is the width direction of the glass substrate 10 and the direction extending from the first side surface 100s1 to the second side surface 100s2 is referred to as a Y direction. In addition, a direction that is the height direction of the glass substrate 10 and the direction extending from the bottom surface 100b to the top surface 100t is referred to as a Z direction. The X direction, the Y direction, and the Z direction are orthogonal to each other and constitute a left-handed system when arranged in order of X, Y, and Z.

In the specification, the outer surface 100 of the glass substrate 10 is not merely a surface facing an outer peripheral side of the glass substrate 10, but is a surface serving as a boundary between an outer side and an inner side of the glass substrate 10. In addition, an “upper side of the outer surface 100 of the glass substrate 10” does not indicate an absolute one direction that is regulated by the gravitational direction such as a vertically upper side, but indicates a direction extending, based on the outer surface 100, toward the outer side of the outer side and the inner side having the outer surface 100 as a boundary. Therefore, the “upper side of the outer surface 100” is a relative direction determined by the direction of the outer surface 100. In addition, when the term “above” is used with respect to a certain element, the term indicates not only a position on an upper side separated from the element such as a position on an upper side of the element with another object on the element interposed therebetween or a position of an upper side with a space, but also a position on the element, which is a position directly above the element and in contact with the element. The glass substrate 10 has insulation. The glass substrate 10 is preferably a glass substrate having photosensitivity represented by, for example, Foturan II (registered trademark of Schott AG). In particular, the glass substrate 10 preferably contains a cerium oxide (ceria: CeO₂), and in this case, since the cerium oxide becomes a sensitizer, processing by photolithography can be easily performed.

However, since the glass substrate 10 can be processed by machine processing such as drilling and sand blasting, dry/wet etching processing using a photoresist metal mask, laser processing, and the like, a glass plate not having photosensitivity may be used. In addition, the glass substrate 10 may be obtained by sintering a glass paste, or may be formed by a known method such as a float process.

Coil 110

The coil 110 is wound into a spiral shape along an axis AX. The axis AX of the coil 110 is disposed in parallel with the bottom surface 100b. The coil 110 includes a plurality of bottom surface conductors 11b, a plurality of top surface conductors 11t, a plurality of first through conductors 13, and a plurality of second through conductors 14. The bottom surface conductors 11b and the top surface conductors 11t correspond to examples of the “outer surface conductor” described in the claims.

The plurality of bottom surface conductors 11b is in contact with the bottom surface 100b and arranged along the axis AX. The plurality of top surface conductors 11t is in contact with the top surface 100t and arranged along the axis AX. The plurality of first through conductors 13 penetrates the glass substrate 10, extends from the bottom surface conductors 11b toward the top surface conductors 11t, and is arranged along the axis AX. The plurality of second through conductors 14 penetrates the glass substrate 10, extends from the bottom surface conductors 11b toward the top surface conductors 11t, and is arranged along the axis AX. The second through conductors 14 are provided on a side opposite to the first through conductors 13 across the axis AX. The bottom surface conductors 11b, the first through conductors 13, the top surface conductors 11t, and the second through conductors 14 are connected in this order and configure at least a part of the coil 110 having a spiral shape.

The top surface conductors 11t are slightly inclined in the X direction and extend in the Y direction. All the top surface conductors 11t are arranged in parallel in the X direction. The bottom surface conductors 11b have a shape extending in the Y direction. All the bottom surface conductors 11b are arranged in parallel in the X direction.

The first through conductors 13 are arranged on the first side surface 100s1 side with respect to the axis AX in a through hole of the glass substrate 10, and the second through conductors 14 are arranged on the second side surface 100s2 side with respect to the axis AX in the through hole of the glass substrate 10. The first through conductors 13 and the second through conductors 14 each extend in a direction orthogonal to the bottom surface 100b and the top surface 100t. All the first through conductors 13 and all the second through conductors 14 are arranged in parallel in the X direction.

The bottom surface conductors 11b and the top surface conductors 11t are made of a conductor material of copper, silver, gold, or an alloy thereof, or the like. The bottom surface conductors 11b and the top surface conductors 11t may be metal films formed by plating, evaporation, sputtering, or the like, or sintered metal bodies obtained by applying and sintering a conductor paste. In addition, the material for the first through conductors 13 and the second through conductors 14 is the same as the material for the bottom surface conductors 11b and the top surface conductors 11t.

The bottom surface conductors 11b and the top surface conductors 11t are preferably formed by a semi-additive method, as a result of which the bottom surface conductors 11b and the top surface conductors 11t having low electric resistance, high precision, and a high aspect can be formed. The first through conductors 13 and the second through conductors 14 can be formed in a through hole formed in advance in the glass substrate 10 by using the exemplified materials and methods for the bottom surface conductors 11b and the top surface conductors 11t.

First Protective Film 15 and Second Protective Film 16

The first protective film 15 covers the top surface 100t of the glass substrate 10 and top surface conductors 11t and is in contact with the top surface 100t and the top surface conductors 11t. The first protective film 15 covers the top surface conductors 11t so as to protect the top surface conductors 11t from an external force and prevent a damage on the top surface conductors 11t.

The second protective film 16 covers the bottom surface 100b of the glass substrate 10 and bottom surface conductors 11b and is in contact with the bottom surface 100b and the bottom surface conductors 11b. The second protective film 16 covers the bottom surface conductors 11b so as to protect the bottom surface conductors 11b from an external force and prevent a damage on the bottom surface conductors 11b.

The first protective film 15 and the second protective film 16 have insulation and are formed of, for example, a resin of epoxy or polyimide.

First Terminal Electrode 121 and Second Terminal Electrode 122

The first terminal electrode 121 is connected to a first end portion of the coil 110, and the second terminal electrode 122 is connected to a second end portion of the coil 110. The first terminal electrode 121 is provided on the first end surface 100e1 side with respect to the center in the X direction of the glass substrate 10 on the second protective film 16. The second terminal electrode 122 is provided on the second end surface 100e2 side with respect to the center in the X direction of the glass substrate 10 on the second protective film 16.

The first terminal electrode 121 is connected to the bottom surface conductors 11b via a first via conductor 121v embedded in the second protective film 16. The second terminal electrode 122 is connected to the bottom surface conductors 11b via a second via conductor 122v embedded in the second protective film 16.

The first terminal electrode 121 has a ground layer and a plating layer that covers the ground layer. The ground layer includes a conductive material such as Ag and Cu. The plating layer includes a conductive material such as Ni, Sn, Pd, and Au. Similarly, the second terminal electrode 122 has a ground layer and a plating layer that covers the ground layer. Note that the first terminal electrode 121 and the second terminal electrode 122 may be formed of a single-layered conductor material.

Surface Roughness

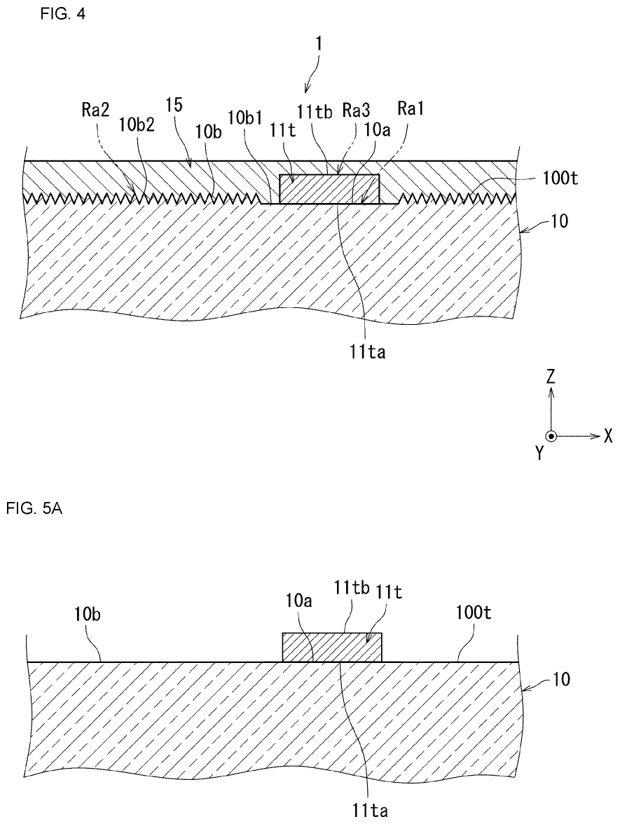

FIG. 4 is an enlarged sectional view of the inductor component 1. As illustrated in FIG. 4, the glass substrate 10 has a first surface 10a in contact with each top surface conductor 11t and a second surface 10b in contact with the first protective film 15. The top surface conductor 11t has a first surface 11ta in contact with the glass substrate 10 and a second surface 11tb in contact with the first protective film 15.

When the first surface 10a of the glass substrate 10 has first surface roughness Ra1 at an interface between the glass substrate 10 and the top surface conductor 11t, the second surface 10b of the glass substrate 10 has second surface roughness Ra2 at an interface between the glass substrate 10 and the first protective film 15, and the second surface 11tb of the top surface conductor 11t has third surface roughness Ra3 at an interface between the top surface conductor 11t and the first protective film 15, Ra1<Ra3<Ra2 is satisfied.

Here, the first surface roughness Ra1 of the glass substrate 10 is the average value of the surface roughness in the entire region of the interface between the glass substrate 10 and the top surface conductor 11t (that is, the first surface 10a of the glass substrate 10). The second surface roughness Ra2 of the glass substrate 10 is the average value of the surface roughness in the entire region of the interface between the glass substrate 10 and the first protective film 15 (that is, the second surface 10b of the glass substrate 10). The third surface roughness Ra3 of the top surface conductor 11t is the average value of the surface roughness in the entire region of the interface between the top surface conductor 11t and the first protective film 15 (that is, the second surface 11tb of the top surface conductor 110.

In addition, as a method for measuring the surface roughness, a scanning electron microscope (SEM) image of an XZ section including the axis AX of the inductor component 1 is obtained, the arithmetic average roughness of the measured region is calculated from the SEM image, and the calculated value is set as the surface roughness of the measured region. For example, the arithmetic average roughness is calculated for a range having a 70 μm length by analyzing an SEM image. When the length of 70 μm cannot be secured, a surface, near the XZ section including the axis AX, from which the largest length can be secured, is polished and calculated. For example, the first surface roughness Ra1 is 0.05 μm, the second surface roughness Ra2 is 5 μm, and the third surface roughness Ra3 is 0.5 μm.

According to the above configuration, since Ra1<Ra3<Ra2 is satisfied, loss of a high frequency signal can be reduced, and peeling of the first protective film 15 can be reduced.

Specifically, since the first surface roughness Ra1 of the glass substrate 10 is the smallest, the surface roughness of the first surface 11ta of the top surface conductor 11t in contact with the glass substrate 10 becomes small. Therefore, when a high frequency signal passes through the first surface 11ta of the top surface conductor 11t, the concentration of a current on the first surface 11ta of the top surface conductor 11t can be reduced, and the loss of the high frequency signal can be reduced. Moreover, since the third surface roughness Ra3 of the top surface conductor 11t is smaller than the second surface roughness Ra2 of the glass substrate 10, the surface roughness of the second surface 11tb of the top surface conductor 11t in contact with the first protective film 15 becomes small. Therefore, when a high frequency signal passes through the second surface 11tb of the top surface conductor 11t, the concentration of a current on the second surface 11tb of the top surface conductor 11t can be reduced, and the loss of the high frequency signal can be further reduced.

On the other hand, since the second surface roughness Ra2 of the glass substrate 10 is the largest, the adhesion between the first protective film 15 and the glass substrate 10 can be improved, and the peeling of the first protective film 15 can be reduced. Moreover, since the third surface roughness Ra3 of the top surface conductor 11t is larger than the first surface roughness Ra1 of the glass substrate 10, the adhesion between the first protective film 15 and the top surface conductor 11t can be improved, and the peeling of the first protective film 15 can be further reduced.

Preferably, (Ra3−Ra1)<(Ra2−Ra3) is satisfied. According to the above configuration, since the third surface roughness Ra3 is closer to the first surface roughness Ra1 than the second surface roughness Ra2, the surface roughness of the second surface 11tb of the top surface conductor 11t in contact with the first protective film 15 becomes small. Therefore, when a high frequency signal passes through the second surface 11tb of the top surface conductor 11t, the concentration of a current on the second surface 11tb of the top surface conductor 11t can be reduced, and the loss of the high frequency signal can be further reduced.

Alternatively, (Ra3−Ra1)>(Ra2−Ra3) may be satisfied. According to the above configuration, since the third surface roughness Ra3 is closer to the second surface roughness Ra2 than the first surface roughness Ra1, the surface roughness of the second surface 11tb of the top surface conductor 11t in contact with the first protective film 15 becomes large. Therefore, the adhesion between the top surface conductor 11t and the first protective film 15 can be improved, and the peeling of the first protective film 15 can be further reduced.

Preferably, the second surface 10b of the glass substrate 10 includes a first region around the top surface conductor 11t and a second region 10b2 other than the first region 10b1. The surface roughness of the first region 10b1 is the same as the first surface roughness Ra1. The surface roughness of the second region 10b2 is much larger than the first surface roughness Ra1, the surface roughness of the second surface 10b (the first region and the second region 10b2) becomes larger than the first surface roughness Ra1.

Preferably, when the glass substrate 10 has the first surface roughness Ra1 at an interface between the glass substrate 10 and each bottom surface conductor 11b, the glass substrate 10 has the second surface roughness Ra2 at an interface between the glass substrate and the second protective film 16, and the bottom surface conductor 11b has the third surface roughness Ra3 at an interface between the bottom surface conductor 11b and the second protective film 16, Ra1<Ra3<Ra2 is satisfied. As a result, the loss of a high frequency signal can be reduced, and the peeling of the second protective film 16 can be reduced.

At this time, (Ra3−Ra1)<(Ra2−Ra3) may be satisfied, or (Ra3−Ra1)>(Ra2−Ra3) may be satisfied. Note that it is sufficient as long as Ra1<Ra3<Ra2 is satisfied in at least either one of the top surface conductor 11t and the bottom surface conductor 11b.

Method for Manufacturing Inductor Component 1

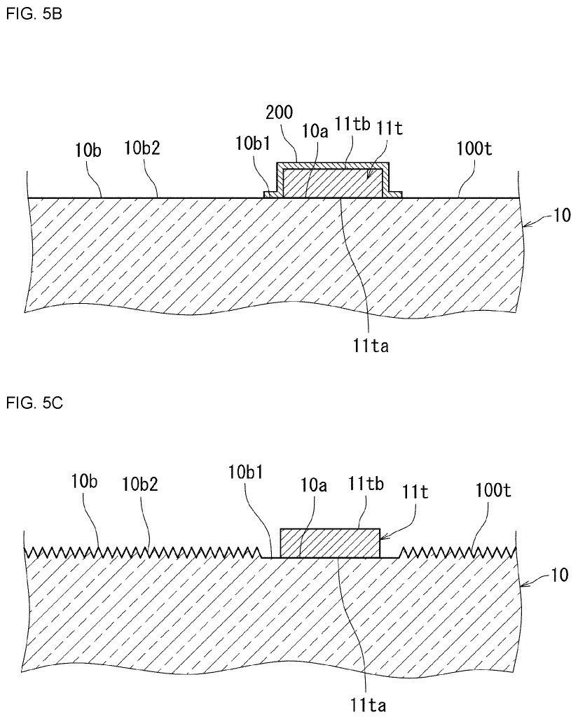

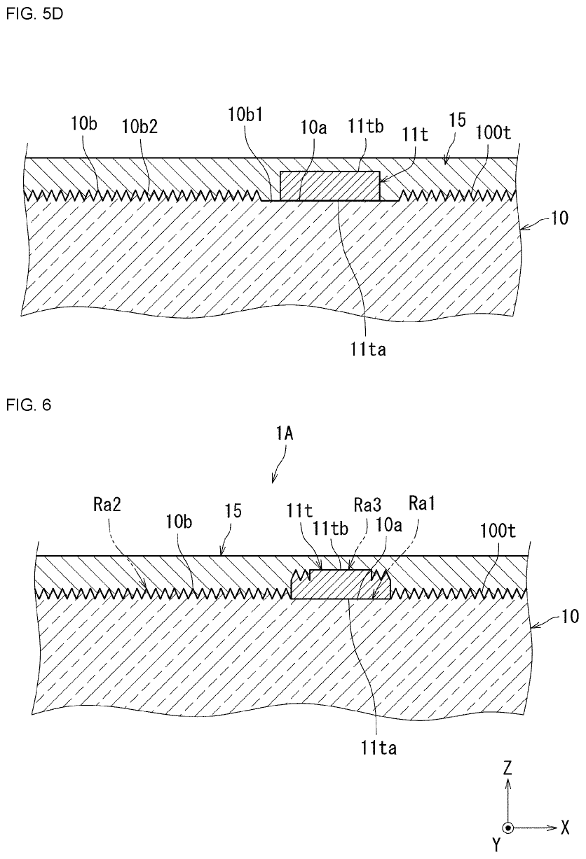

Next, a method for manufacturing the inductor component 1 will be described with reference to FIGS. 5A to 5D.

As illustrated in FIG. 5A, the glass substrate 10 is prepared. The glass substrate 10 is, for example, formed of a photosensitive glass and is easily performed with processing for a through hole, or the like. In addition, it is desired that a surface of the glass substrate 10 is significantly flat.

In addition, the top surface conductor 11t in contact with the top surface 100t of the glass substrate 10 is provided. The top surface conductor 11t is formed by, for example, a semi-additive method. Note that the top surface conductor 11t may be formed by screen printing.

Here, the top surface 100t is smooth. That is, the first surface 10a, of the top surface 100t, in contact with the top surface conductor 11t and the second surface 10b, of the top surface 100t, exposed from the top surface conductor 11t are smooth. In this manner, since the first surface 10a of the top surface 100t is smooth, the first surface 11ta of the top surface conductor 11t in contact with the first surface 10a of the top surface 100t is smooth. On the other hand, when the top surface conductor 11t is formed, the flatness of the second surface 11tb, which is an exposed surface of the top surface conductor 11t, is made lower than the flatness of the first surface 11ta of the top surface conductor 11t.

As illustrated in FIG. 5B, a mask 200 is provided over the entire second surface 11tb of the top surface conductor 11t. The mask 200 further covers the first region 10b1 around the top surface conductor 11t, of the second surface 10b of the top surface 100t.

As illustrated in FIG. 5C, a surface treatment is performed on the top surface 100t of the glass substrate 10, and the mask 200 is removed from the top surface conductor 11t. As the surface treatment, for example, etching or sand blasting is used. As a result, the surface of the second region 10b2 other than the first region 10b1, of the second surface 10b of the top surface 100t, is performed with the surface treatment and becomes rough. On the other hand, the surface of the second surface 11tb of the top surface conductor 11t and the surface of the first region 10b1 of the second surface 10b of the top surface 100t are not performed with the surface treatment and are not rough.

Therefore, since the mask 200 is provided over the top surface conductor 11t, and then the surface treatment is performed on the top surface 100t of the glass substrate 10, the surface treatment can be selectively performed not on the surface of the top surface conductor 11t, but on the top surface 100t of the glass substrate 10. Note that the surface treatment may be performed without providing a mask.

The surface roughness of the second region 10b2 of the second surface 10b of the top surface 100t is larger than the surface roughness of the first region 10b1 of the second surface 10b of the top surface 100t, the surface roughness of the first surface 10a of the top surface 100t, and the surface roughness of the second surface 11tb of the top surface conductor 11t. The surface roughness of the first region 10b1 of the second surface 10b of the top surface 100t is the same as the surface roughness of the first surface 10a of the top surface 100t. The surface roughness of the second surface 11tb of the top surface conductor 11t is larger than the first surface 10a of the top surface 100t.

The surface roughness of the second surface 10b of the top surface 100t is larger than the surface roughness of the first surface 10a of the top surface 100t and the surface roughness of the second surface 11tb of the top surface conductor 11t. The surface roughness of the second surface 10b of the top surface 100t is the average surface roughness of the entire region including the first region 10b1 and the second region 10b2.

As illustrated in FIG. 5D, the first protective film 15 that covers the top surface 100t of the glass substrate 10 and the top surface conductor 11t and is in contact with the top surface 100t of the glass substrate 10 and the top surface conductor 11t is provided. As this time, when the first surface 10a of the glass substrate 10 has the first surface roughness Ra1 at the interface between the glass substrate 10 and the top surface conductor 11t, the second surface 10b of the glass substrate 10 has the second surface roughness Ra2 at the interface between the glass substrate 10 and the first protective film 15, and the second surface 11tb of the top surface conductor 11t has the third surface roughness Ra3 at the interface between the top surface conductor 11t and the first protective film 15, Ra1<Ra3<Ra2 is satisfied. According to this configuration, since Ra1<Ra3<Ra2 is satisfied, the loss of a high frequency signal can be reduced, and the peeling of the first protective film 15 can be reduced.

In addition, although not illustrated, the bottom surface conductor 11b and the second protective film 16 are formed in the same manner as the top surface conductor 11t and the first protective film 15. Each first through conductor 13 and each second through conductor 14 are formed in the through hole provided in the glass substrate 10 before the top surface conductor 11t and the bottom surface conductor 11b are provided. Finally, the first terminal electrode 121 and the second terminal electrode 122 are provided, and the inductor component 1 illustrated in FIG. 2 is manufactured.

### Second Embodiment

FIG. 6 is an enlarged sectional view illustrating a second embodiment of an inductor component as an electronic component. The second embodiment is different from the first embodiment in the interface between the glass substrate 10 and the first protective film 15 and the interface between the top surface conductor 11t and the first protective film 15. The different configuration will be described below. Other configurations are the same as the configurations of the first embodiment, and the description thereof will be omitted.

As illustrated in FIG. 6, in an inductor component 1A of the second embodiment, the second surface 10b of the glass substrate 10 has uniform surface roughness in the entire region of the second surface 10b at the interface between the glass substrate 10 and the first protective film 15. As a result, the adhesion between the glass substrate 10 and the first protective film 15 can be improved.

In addition, the surface roughness of a part of the region of the second surface 11tb of the top surface conductor 11t at the interface between the top surface conductor 11t and the first protective film 15 is larger than the surface roughness of other regions of the second surface 11tb. As a result, the adhesion between the top surface conductor 11t and the first protective film 15 can be improved. In addition, by making the surface roughness of other regions of the second surface 11tb small, the loss of a high frequency signal that passes through the top surface conductor 11t can be reduced. Here, the surface roughness of the second surface 11tb of the top surface conductor 11t is the average surface roughness of the entire region including a part of the region of the second surface 11tb and other regions of the second surface 11tb.

Similarly to the first embodiment, when the first surface 10a of the glass substrate has the first surface roughness Ra1 at the interface between the glass substrate 10 and the top surface conductor 11t, the second surface 10b of the glass substrate 10 has the second surface roughness Ra2 at the interface between the glass substrate 10 and the first protective film 15, and the second surface 11tb of the top surface conductor 11t has the third surface roughness Ra3 at the interface between the top surface conductor 11t and the first protective film 15, Ra1<Ra3<Ra2 is satisfied. As a result, since Ra1<Ra3<Ra2 is satisfied, the loss of a high frequency signal can be reduced, and the peeling of the first protective film can be reduced.

Method for Manufacturing Inductor Component 1A

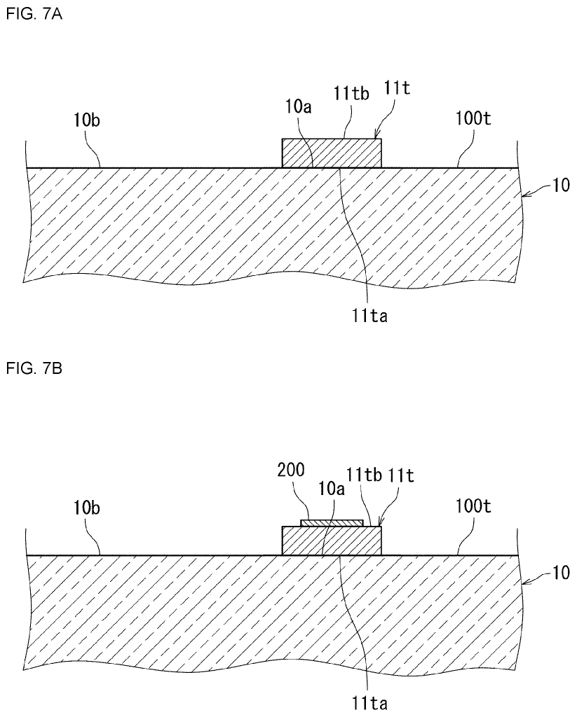

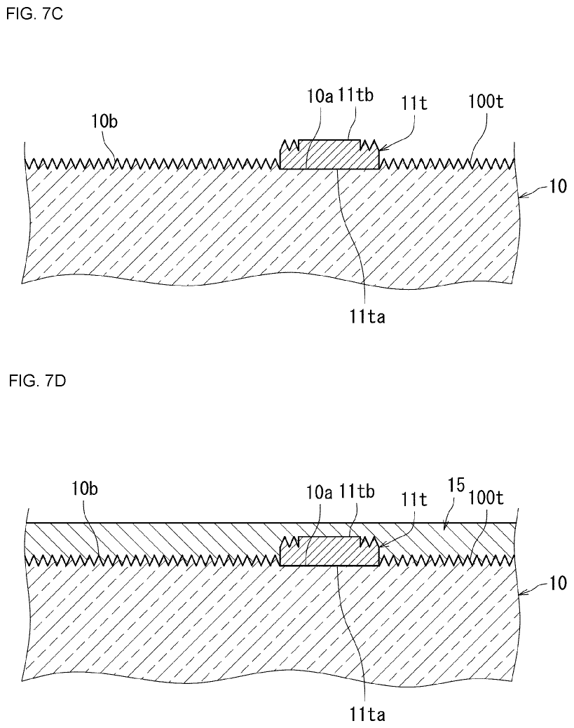

Next, a method for manufacturing the inductor component 1A will be described with reference to FIGS. 7A to 7D. In the configuration of each member and the method, the description of a portion that is the same as the first embodiment will be omitted, and a portion that is different from the first embodiment will be described.

As illustrated in FIG. 7A, the top surface conductor 11t in contact with the top surface 100t of the glass substrate 10 is provided. Since the configurations of the glass substrate 10 and the top surface conductor 11t are the same as the first embodiment, the description thereof will be omitted.

As illustrated in FIG. 7B, the mask 200 is provided on a part of the second surface 11tb of the top surface conductor 11t. The mask 200 is provided on only a part of the upper surface of the second surface 11tb.

As illustrated in FIG. 7C, a surface treatment is performed on the top surface 100t of the glass substrate 10, and the mask 200 is removed from the top surface conductor 11t. As a result, the surface of the second surface 10b of the top surface 100t is performed with the surface treatment and becomes rough. In addition, a non-covered region, of the upper surface of the second surface 11tb of the top surface conductor 11t, that is not covered with the mask 200 is treated with the surface treatment and becomes rough. On the other hand, other regions than the non-covered region of the second surface 11tb of the top surface conductor 11t are not treated with the surface treatment and is not rough.

The surface roughness of the second surface 10b of the top surface 100t is larger than the surface roughness of the first surface 10a of the top surface 100t and the surface roughness of the second surface 11tb of the top surface conductor 11t. The surface roughness of the second surface 11tb of the top surface conductor 11t is larger than the surface roughness of the first surface 10a of the top surface 100t. The surface roughness of the second surface 11tb of the top surface conductor 11t is the average surface roughness of the entire region including the non-covered region and regions other than the non-covered region of the second surface 11tb.

As illustrated in FIG. 7D, the first protective film 15 that covers the top surface 100t of the glass substrate 10 and the top surface conductor 11t and is in contact with the top surface 100t of the glass substrate 10 and the top surface conductor 11t is provided. At this time, when the first surface 10a of the glass substrate 10 has the first surface roughness Ra1 at the interface between the glass substrate 10 and the top surface conductor 11t, the second surface 10b of the glass substrate 10 has the second surface roughness Ra2 at the interface between the glass substrate 10 and the first protective film 15, and the second surface 11tb of the top surface conductor 11t has the third surface roughness Ra3 at the interface between the top surface conductor 11t and the first protective film 15, Ra1<Ra3<Ra2 is satisfied. According to this configuration, since Ra1<Ra3<Ra2 is satisfied, the loss of a high frequency signal can be reduced, and the peeling of the first protective film 15 can be reduced.

In addition, although not illustrated, the bottom surface conductor 11b and the second protective film 16 are formed in the same manner as the top surface conductor 11t and the first protective film 15. The first through conductor 13 and the second through conductor 14 are formed in the through hole provided in the glass substrate 10 before the top surface conductor 11t and the bottom surface conductor 11b are provided. Finally, the first terminal electrode 121 and the second terminal electrode 122 are provided, and the inductor component 1A illustrated in FIG. 6 is manufactured.

### Third Embodiment

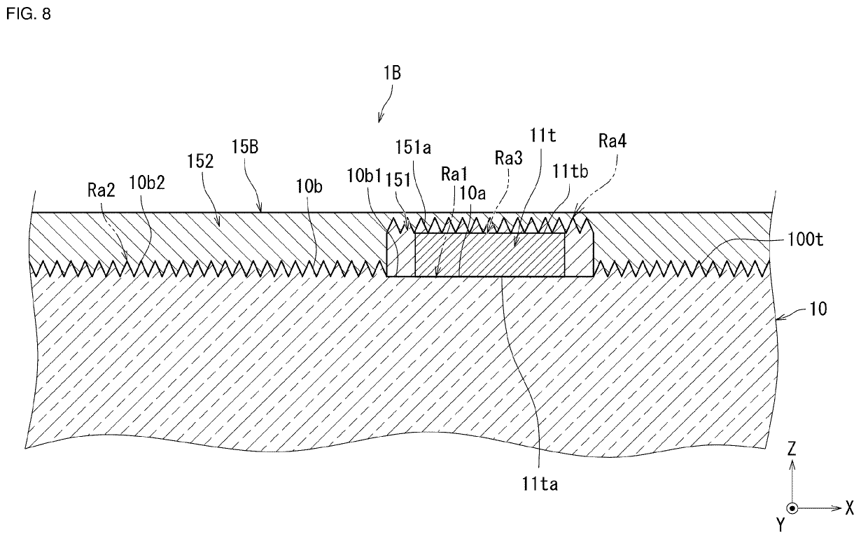

FIG. 8 is an enlarged sectional view illustrating a third embodiment of an inductor component as an electronic component. The third embodiment is different from the first embodiment in the configuration of a first protective film 15B. The different configuration will be described below. Other configurations are the same as the configurations of the first embodiment, and the description thereof will be omitted.

As illustrated in FIG. 8, in an inductor component 1B of the third embodiment, the first protective film 15B has a first protective layer 151 that covers the top surface conductor 11t and a second protective layer 152 that covers the first protective layer 151 and the top surface 100t of the glass substrate 10.

Specifically, the first protective layer 151 covers all of the second surface 11tb of the top surface conductor 11t and also covers the first region 10b1 of the second surface 10b of the top surface 100t. The second protective layer 152 covers all of the first protective layer 151 and also covers the second region 10b2 of the second surface 10b of the top surface 100t.

According to the above configuration, the third surface roughness Ra3 of the top surface conductor 11t at an interface between the top surface conductor 11t and the first protective film 15B (the first protective layer 151) is made small, and thus the surface roughness of the second surface 11tb of the top surface conductor 11t in contact with the first protective film 15B can be made small. Therefore, when a high frequency signal passes through the second surface 11tb of the top surface conductor 11t, the concentration of a current on the second surface 11tb of the top surface conductor 11t can be reduced, and the loss of the high frequency signal can be further reduced.

Moreover, even when the third surface roughness Ra3 of the top surface conductor 11t is made small, as a fourth surface roughness Ra4 of the first protective layer 151 at an interface between the first protective layer 151 and the second protective layer 152 is made large, the adhesion between the first protective layer 151 and the second protective layer 152 can be improved, and thus the peeling of the second protective layer 152 can be reduced.

Preferably, in the relationship between the first surface roughness Ra1 and the fourth surface roughness Ra4, Ra1<Ra4 is satisfied. Specifically, the first protective layer 151 includes a first surface 151a in contact with the second protective layer 152. The surface roughness of a part of the region (upper surface) of the first surface 151a is larger than the surface roughness of the first surface 10a of the glass substrate 10. The surface roughness of the first surface 151a of the first protective layer 151 is the average surface roughness of the entire region including a part of the region of the first surface 151a and other regions of the first surface 151a.

According to the above configuration, since the fourth surface roughness Ra4 is larger than the first surface roughness Ra1, the adhesion between the first protective layer 151 and the second protective layer 152 can be improved, and the peeling of the second protective layer 152 can be reduced.

Similarly to the first embodiment, when the first surface 10a of the glass substrate has the first surface roughness Ra1 at the interface between the glass substrate 10 and the top surface conductor 11t, the second surface 10b of the glass substrate 10 has the second surface roughness Ra2 at the interface between the glass substrate 10 and the first protective film 15B, and the second surface 11tb of the top surface conductor 11t has the third surface roughness Ra3 at the interface between the top surface conductor 11t and the first protective film 15B, Ra1<Ra3<Ra2 is satisfied. According to this configuration, since Ra1<Ra3<Ra2 is satisfied, the loss of a high frequency signal can be reduced, and the peeling of the first protective film 15B can be reduced.

Method for Manufacturing Inductor Component 1B

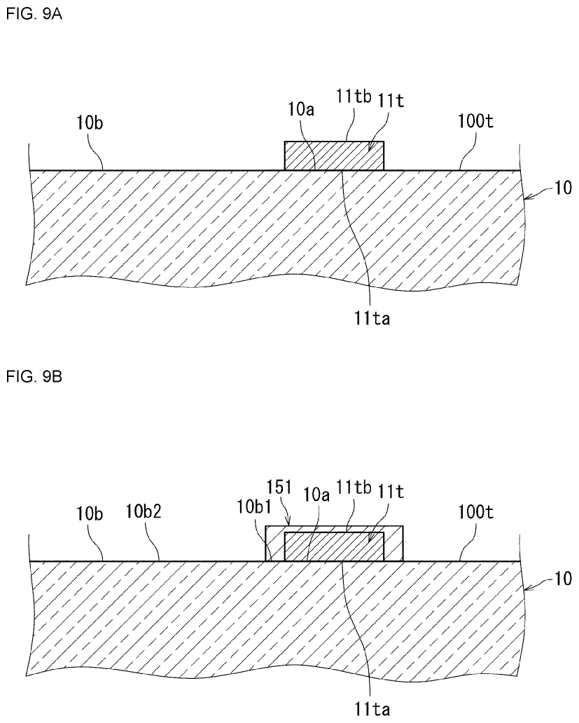

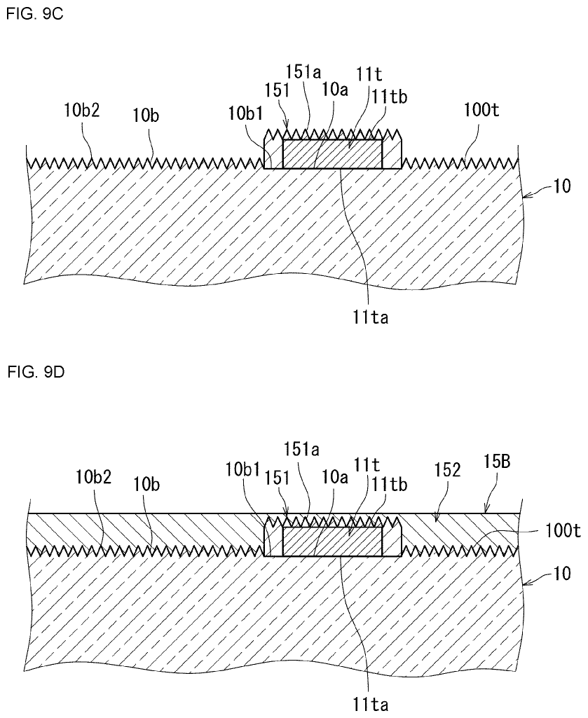

Next, a method for manufacturing the inductor component 1B will be described with reference to FIGS. 9A to 9D. In the configuration of each member and the method, the description of a portion that is the same as the first embodiment will be omitted, and a portion that is different from the first embodiment will be described.

As illustrated in FIG. 9A, the top surface conductor 11t in contact with the top surface 100t of the glass substrate 10 is provided. Since the configurations of the glass substrate 10 and the top surface conductor 11t are the same as the first embodiment, the description thereof will be omitted.

As illustrated in FIG. 9B, the first protective layer 151 is provided on all of the second surface 11tb of the top surface conductor 11t. The first protective layer 151 further covers the first region 10b1 of the second surface 10b of the top surface 100t.

As illustrated in FIG. 9C, a surface treatment is performed on the top surface 100t of the glass substrate 10 and the first surface 151a of the first protective layer 151. As a result, the surface of the second region 10b2 of the second surface 10b of the top surface 100t is performed with the surface treatment and becomes rough. In addition, a part of the region (upper surface) of the first surface 151a of the first protective layer 151 is performed with the surface treatment and becomes rough. On the other hand, regions other than a part of the first surface 151a of the first protective layer 151 is not performed with the surface treatment and is not rough.

The surface roughness of the second region 10b2 of the second surface 10b of the top surface 100t is larger than the surface roughness of the first region 10b1 of the second surface 10b of the top surface 100t, the surface roughness of the first surface 10a of the top surface 100t, and the surface roughness of the second surface 11tb of the top surface conductor 11t. The surface roughness of the first region 10b1 of the second surface 10b of the top surface 100t is the same as the surface roughness of the first surface 10a of the top surface 100t. The surface roughness of the second surface 11tb of the top surface conductor 11t is larger than the surface roughness of the first surface 10a of the top surface 100t. The surface roughness of the second surface 10b of the top surface 100t is larger than the surface roughness of the first surface 10a of the top surface 100t, and the surface roughness of the second surface 11tb of the top surface conductor 11t. The surface roughness of the second surface 10b of the top surface 100t is the average surface roughness of the entire region including the first region 10b1 and the second region 10b2.

The surface roughness of the first surface 151a of the first protective layer 151 is larger than the surface roughness of the first surface 10a of the top surface 100t. The surface roughness of the first surface 151a of the first protective layer 151 is the average surface roughness of the entire region including the region of the upper surface of the first surface 151a and the regions of the side surfaces.

As illustrated in FIG. 9D, the second protective layer 152 that covers the top surface 100t of the glass substrate 10 and the first protective layer 151 and is in contact with the top surface 100t of the glass substrate 10 and the first surface 151a of the first protective layer 151. At this time, when the first surface 10a of the glass substrate 10 has the first surface roughness Ra1 at the interface between the glass substrate 10 and the top surface conductor 11t, the second surface 10b of the glass substrate 10 has the second surface roughness Ra2 at the interface between the glass substrate 10 and the first protective film 15B, and the second surface 11tb of the top surface conductor 11t has the third surface roughness Ra3 at the interface between the top surface conductor 11t and the first protective film 15B, Ra1<Ra3<Ra2 is satisfied. According to this configuration, since Ra1<Ra3<Ra2 is satisfied, the loss of a high frequency signal can be reduced, and the peeling of the first protective film 15B can be reduced.

In addition, although not illustrated, the bottom surface conductor 11b and the second protective film 16 are formed in the same manner as the top surface conductor 11t and the first protective film 15. The first through conductor 13 and the second through conductor 14 are formed in the through hole provided in the glass substrate 10 before the top surface conductor 11t and the bottom surface conductor 11b are provided. Finally, the first terminal electrode 121 and the second terminal electrode 122 are provided, and the inductor component 1B illustrated in FIG. 8 is manufactured.

### Fourth Embodiment

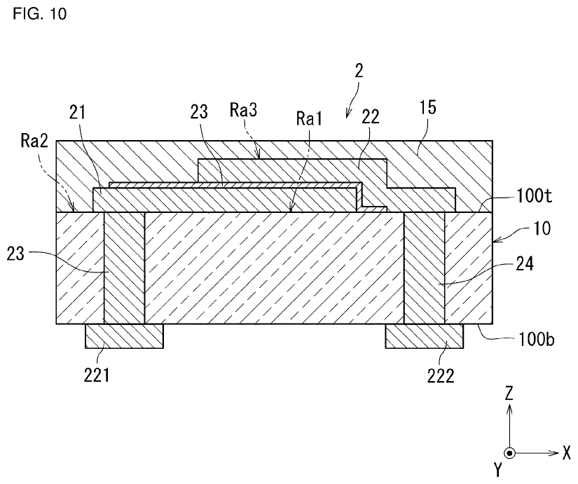

In a fourth embodiment, a capacitor component will be described as an example of an electronic component according to the present disclosure. FIG. 10 is a sectional view of a capacitor component. A capacitor component 2 is, for example, a surface-mounting capacitor component used for a high frequency signal transmission circuit.

As illustrated in FIG. 10, the capacitor component 2 includes the glass substrate 10, a first flat plate electrode 21 and a second flat plate electrode 22 provided on the glass substrate 10, the first protective film 15 that is provided on the glass substrate 10 and covers the first flat plate electrode 21 and the second flat plate electrode 22, and a first terminal electrode 221 and a second terminal electrode 222 provided on the glass substrate 10. The first flat plate electrode 21 and the second flat plate electrode 22 correspond to examples of the “outer surface conductor” described in the claims.

Note that the material of the glass substrate 10 is the same as the material of the glass substrate 10 of the first embodiment. The material of the first protective film 15 is the same as the material of the first protective film 15 of the first embodiment. The material of the first flat plate electrode 21 and the second flat plate electrode 22 is the same as the material of the top surface conductor 11t and the bottom surface conductor 11b of the first embodiment. The material of the first terminal electrode 221 and the second terminal electrode 222 is the same as the material of the first terminal electrode 121 and the second terminal electrode 122 of the first embodiment.

The first flat plate electrode 21 and the second flat plate electrode 22 are provided on the top surface 100t of the glass substrate 10. The first flat plate electrode 21 is in contact with the top surface 100t of the glass substrate 10, and the second flat plate electrode 22 is located above the first flat plate electrode 21. A dielectric film 23 is provided between the first flat plate electrode 21 and the second flat plate electrode 22. The first flat plate electrode 21, the second flat plate electrode 22, and the dielectric film 23 configure a capacitor element.

The first terminal electrode 221 and the second terminal electrode 222 are in contact with the bottom surface 100b of the glass substrate 10. The first terminal electrode 221 and the second terminal electrode 222 are separated from each other.

The capacitor component 2 further includes a first through conductor 23 and a second through conductor 24 that penetrate the glass substrate 10. The first through conductor 23 is connected between the first terminal electrode 221 and the first flat plate electrode 21. The second through conductor 24 is connected between the second terminal electrode 222 and the second flat plate electrode 22.

When the glass substrate 10 has the first surface roughness Ra1 at an interface between the glass substrate 10, and the first flat plate electrode 21 and the second flat plate electrode 22, the glass substrate 10 has the second surface roughness Ra2 at an interface between the glass substrate 10 and the first protective film 15, and the first flat plate electrode 21 and the second flat plate electrode 22 have the third surface roughness Ra3 at an interface between the first flat plate electrode 21 and the second flat plate electrode 22, and the first protective film 15, Ra1<Ra3<Ra2 is satisfied.

According to the above configuration, since Ra1<Ra3<Ra2 is satisfied, the loss of a high frequency signal flowing through the first flat plate electrode 21 and the second flat plate electrode 22 can be reduced, and the peeling of the first protective film 15 can be reduced.

Note that the present disclosure is not limited to the above-described embodiments, and their designs may be changed within the scope not departing from the gist of the present disclosure. For example, the features of each of the first to the fourth embodiments may variously be combined with each other. Although an inductor component is used as an electronic component in the first to the third embodiments, and a capacitor component is used as an electronic component in the fourth embodiment, other electronic components such as a resistor component may be used.
<1> An electronic component including a glass substrate; an outer surface conductor that is in contact with an outer surface of the glass substrate; and a protective film that covers the outer surface of the glass substrate and the outer surface conductor and is in contact with the outer surface of the glass substrate and the outer surface conductor. When the glass substrate has first surface roughness Ra1 at an interface between the glass substrate and the outer surface conductor, the glass substrate has second surface roughness Ra2 at an interface between the glass substrate and the protective film, and the outer surface conductor has third surface roughness Ra3 at an interface between the outer surface conductor and the protective film, Ra1<Ra3<Ra2 is satisfied.
<2> The electronic component described in <1>, in which (Ra3−Ra1)<(Ra2−Ra3) is satisfied.
<3> The electronic component described in <1> or <2>, further including a first through conductor and a second through conductor that penetrate the glass substrate, in which the outer surface includes a bottom surface, which is one main surface of the glass substrate, and a top surface located on a back side of the bottom surface, the outer surface conductor includes a bottom surface conductor that is in contact with the bottom surface and a top surface conductor that is in contact with the top surface, and the bottom surface conductor, the first through conductor, the top surface conductor, and the second through conductor are connected in order and configure a part of a spiral coil.
<4> The electronic component described in any one of <1> to <3>, in which the protective film includes a first protective layer that covers the outer surface conductor and a second protective layer that covers the first protective layer and the outer surface of the glass substrate.
<5> The electronic component described in <4>, in which when the first protective layer has fourth surface roughness Ra4 at an interface between the first protective layer and the second protective layer, Ra1<Ra4 is satisfied.
<6> A method for manufacturing an electronic component, including providing an outer surface conductor that is in contact with an outer surface of a glass substrate; performing a surface treatment on the outer surface of the glass substrate; and providing a protective film that covers the outer surface of the glass substrate and the outer surface conductor and is in contact with the outer surface of the glass substrate and the outer surface conductor. When the glass substrate has first surface roughness Ra1 at an interface between the glass substrate and the outer surface conductor, the glass substrate has second surface roughness Ra2 at an interface between the glass substrate and the protective film, and the outer surface conductor has third surface roughness Ra3 at an interface between the outer surface conductor and the protective film, Ra1<Ra3<Ra2 is satisfied.
<7> The method for manufacturing an electronic component described in <6>, in which the performing a surface treatment on the outer surface conductor includes performing a surface treatment on the outer surface of the glass substrate after providing a mask on at least a part of the outer surface conductor, and the providing a protective film includes providing the protective film that covers the outer surface of the glass substrate and the outer surface conductor after removing the mask from the outer surface conductor.
<8> A method for manufacturing an electronic component, including providing an outer surface conductor that is in contact with an outer surface of a glass substrate; providing a first protective layer of a protective film that covers the outer surface conductor and is in contact with the outer surface conductor; performing a surface treatment on the outer surface of the glass substrate and the first protective layer; and providing a second protective layer of the protective film that covers the outer surface of the glass substrate and the first protective layer and is in contact with the outer surface of the glass substrate and the first protective layer. When the glass substrate has first surface roughness Ra1 at an interface between the glass substrate and the outer surface conductor, the glass substrate has second surface roughness Ra2 at an interface between the glass substrate and the second protective layer, and the outer surface conductor has third surface roughness Ra3 at an interface between the outer surface conductor and the first protective layer, Ra1<Ra3<Ra2 is satisfied.

What is claimed is:

1. An electronic component comprising:
a glass substrate;
an outer surface conductor that is in contact with an outer surface of the glass substrate; and
a protective film that covers the outer surface of the glass substrate and the outer surface conductor and is in contact with the outer surface of the glass substrate and the outer surface conductor, wherein
when the glass substrate has first surface roughness Ra1 at an interface between the glass substrate and the outer surface conductor, the glass substrate has second surface roughness Ra2 at an interface between the glass substrate and the protective film, and the outer surface conductor has third surface roughness Ra3 at an interface between the outer surface conductor and the protective film, Ra1<Ra3<Ra2 is satisfied.

2. The electronic component according to claim 1, wherein
(Ra3−Ra1)<(Ra2−Ra3) is satisfied.

3. The electronic component according to claim 1, further comprising:
a first through conductor and a second through conductor that penetrate the glass substrate, wherein
the outer surface includes a bottom surface, which is one main surface of the glass substrate, and a top surface located on a back side of the bottom surface,
the outer surface conductor includes a bottom surface conductor that is in contact with the bottom surface and a top surface conductor that is in contact with the top surface, and
the bottom surface conductor, the first through conductor, the top surface conductor, and the second through conductor are connected in order and configure a part of a spiral coil.

4. The electronic component according to claim 1, wherein
the protective film includes a first protective layer that covers the outer surface conductor and a second protective layer that covers the first protective layer and the outer surface of the glass substrate.

5. The electronic component according to claim 4, wherein
when the first protective layer has fourth surface roughness Ra4 at an interface between the first protective layer and the second protective layer, Ra1<Ra4 is satisfied.

6. The electronic component according to claim 2, further comprising:
a first through conductor and a second through conductor that penetrate the glass substrate, wherein
the outer surface includes a bottom surface, which is one main surface of the glass substrate, and a top surface located on a back side of the bottom surface,
the outer surface conductor includes a bottom surface conductor that is in contact with the bottom surface and a top surface conductor that is in contact with the top surface, and
the bottom surface conductor, the first through conductor, the top surface conductor, and the second through conductor are connected in order and configure a part of a spiral coil.

7. The electronic component according to claim 2, wherein
the protective film includes a first protective layer that covers the outer surface conductor and a second protective layer that covers the first protective layer and the outer surface of the glass substrate.

8. The electronic component according to claim 7, wherein
when the first protective layer has fourth surface roughness Ra4 at an interface between the first protective layer and the second protective layer, Ra1<Ra4 is satisfied.

9. A method for manufacturing an electronic component, comprising:
providing an outer surface conductor that is in contact with an outer surface of a glass substrate;
performing a surface treatment on the outer surface of the glass substrate; and
providing a protective film that covers the outer surface of the glass substrate and the outer surface conductor and is in contact with the outer surface of the glass substrate and the outer surface conductor, wherein
when the glass substrate has first surface roughness Ra1 at an interface between the glass substrate and the outer surface conductor, the glass substrate has second surface roughness Ra2 at an interface between the glass substrate and the protective film, and the outer surface conductor has third surface roughness Ra3 at an interface between the outer surface conductor and the protective film, Ra1<Ra3<Ra2 is satisfied.

10. The method for manufacturing an electronic component according to claim 9, wherein
the performing a surface treatment on the outer surface conductor includes performing a surface treatment on the outer surface of the glass substrate after providing a mask on at least a part of the outer surface conductor, and
the providing a protective film includes providing the protective film that covers the outer surface of the glass substrate and the outer surface conductor after removing the mask from the outer surface conductor.

11. A method for manufacturing an electronic component, comprising:
providing an outer surface conductor that is in contact with an outer surface of a glass substrate;
providing a first protective layer of a protective film that covers the outer surface conductor and is in contact with the outer surface conductor;
performing a surface treatment on the outer surface of the glass substrate and the first protective layer; and
providing a second protective layer of the protective film that covers the outer surface of the glass substrate and the first protective layer and is in contact with the outer surface of the glass substrate and the first protective layer, wherein
when the glass substrate has first surface roughness Ra1 at an interface between the glass substrate and the outer surface conductor, the glass substrate has second surface roughness Ra2 at an interface between the glass substrate and the second protective layer, and the outer surface conductor has third surface roughness Ra3 at an interface between the outer surface conductor and the first protective layer, Ra1<Ra3<Ra2 is satisfied.
